(19) United States
(12) Patent Application Publication
(10) Pub. No.: US 2022/0350028 A1
(43) Pub. Date: Nov. 3, 2022

(54) DOPPLER LIDAR FOR THE DETECTION OF WIND AND/OR VORTEX SITUATIONS

(71) Applicant: LEONARDO Germany GmbH, Neuss (DE)

(72) Inventors: Albert Tows, Wiehl-Brachen (DE); Alfred Kurtz, Koln (DE); Frank Gekat, Rosrath (DE)

(21) Appl. No.: 17/730,740

(22) Filed: Apr. 27, 2022

(30) Foreign Application Priority Data
Apr. 28, 2021 (DE) 10 2021 002 239.4

(51) Int. Cl. G01S 17/95; G01S 17/50; G01S 7/497; G06K 9/00

(52) U.S. Cl. CPC G01S 17/95; G01S 17/50; G01S 7/497; G06K 9/0053

(57) ABSTRACT

Doppler lidar for detecting wind speeds, comprising a device (MO) for generating pulsed coherent laser light on N wavelength channels, amplitude modulation (AM) being performed separately for each individual wavelength channel for shaping the pulse individually for each channel, a device (TK, SC) for transmitting generated, frequency-shifted and amplified pulses of the laser light in predetermined spatial directions, a detector (n×Det.) for receiving the generated and the backscattered laser light on N wavelength channels, and an electronic evaluation device (n×SV) for determining a Doppler shift amount between the transmitted light and the received light on N wavelength channels, wherein a timing modulator (TM) is assigned to the N wavelength channels for individual control of a pulse repetition frequency (PRF) and/or pulse repetition period (PRT) in addition to the pulse shape for wavelength channels.

This application claims the benefit of German Patent Application Serial No. 10 2021 002 239.4, filed on Apr. 28, 2021, entitled “Doppler Lidar for the Detection of Wind and/or Vortex Situations”, the disclosure of which is incorporated by reference herein in its entirety.

The invention relates to a Doppler lidar for detecting wind and/or vortex situations.

As known from DE 10316762 B4, weather radar systems have the problem that they require large suspended particles of high density, such as water droplets in clouds, for their backscatter measurement and are therefore only suitable for early warning of weather clouds at greater distances of up to several 10 kilometers. In contrast, the most common airflow with clear view, such as wind shear and so-called clear air turbulences in the troposphere and jet streams in the stratosphere, cannot be detected by weather radar, because the wavelengths of a few centimeters to millimeters are relatively long compared to the size of the air particles.

Therefore, attempts were made to develop LIDAR (light detection and ranging) systems with shorter wavelengths and higher pulse frequency, which allow additional scanning in the optical region of the spectrum where the smaller air particles can be detected. In order to achieve high measurement reliability in all weather conditions, Doppler shifted backscattering from air molecules was used in addition to aerosol scattering. However, Doppler lidar measurements have the general problem of low intensity of the backscatter signal from both molecules and aerosols. Nevertheless, to keep the laser power low, which is required for reliable measurements, it is necessary to use the most sensitive photodetector possible while efficiently suppressing the influence of noise due to background radiation from the atmosphere and electronic noise in the detector and amplifier. Integration of weak backscatter signals over several seconds would require winds to be stable over time. However, such conditions generally do not exist. Instead, signal evaluation must be performed in only a few tens of milliseconds, i.e., in real time.

As known from DE 10 2005 034 729 B3, meteorological measuring devices installed on the ground, such as Doppler radars and Doppler lidars, provide a global overview of the weather, wind and vortex situation, especially at airport areas. To ensure the safety of take-off and landing at airports, the wind speed in the atmosphere must be measured permanently. Long-range measurements in clear weather conditions can only be carried out with Doppler lidar systems.

Even this is only sufficient for a common warning of critical wind and wake vortex situations at all affected aircrafts, without taking into account the risk to an individual aircraft. In future, a general shortening of take-off and landing sequences at all airports will only be possible when each aircraft has its own on-board measurement system, which can detect individual vortices and wake vortexes from taking-off or landing aircraft on their flight path in all weather conditions in time and directly assess their hazard potential due to forces and torques occurring. However, Doppler lidars for measurement in the clear atmosphere are not as compact as Doppler radars and still complicated overall.

The article “Two-channel direct-detection Doppler lidar employing a charge coupled device as a detector” by Irgang, Todd D., Applied Optics, Vol. 41, No. 6, Feb. 20, 2002, describes a two-channel Doppler lidar that has a CCD (charge-coupled device) as a detector. The lidar system measures wind motion using backscattered light from aerosols and molecules in two separate channels, with light from one channel guided into the other. However, the measuring system is not sufficiently compact to make the inhomogeneity and movement of the air visible in an extended area, i.e. over a larger angular range, simultaneously along and across the measuring axis.

Measuring wind and turbulence conditions for wind farms is also important for large-scale use of wind as a renewable energy source. For wind farms, the effectiveness of power generation depends on the proper placement of rotors in relation to local wind and turbulence conditions. For these reasons, accurate non-contact measurement of the characteristic wind and turbulence field at the selected site under varying weather conditions prior to their construction as well as during operation is of particular importance for efficient and safe operation of wind farms. The measurement of these air data with meteorological measuring stations and occasionally with Doppler lidar systems is still complex, expensive and inaccurate.

In the state of the art known Doppler lidars are in particular pulsed coherent Doppler lidar systems that use the Doppler effect to detect the wind speed in a spatial volume. For this purpose, a laser pulse is emitted into the atmosphere or in the direction of any target to measure. The reflected laser light is detected and coherently mixed with a local oscillator. The heterodyne detection amplifies the backscattered signal and the frequency of the beat signal can be used to determine the Doppler shift. There are two main ways to increase the signal strength. First, the transmit pulse energy can be further increase, which increases also the backscattered signal strength. Second, the pulse repetition rate can increase to increase the number of information per unit of time.

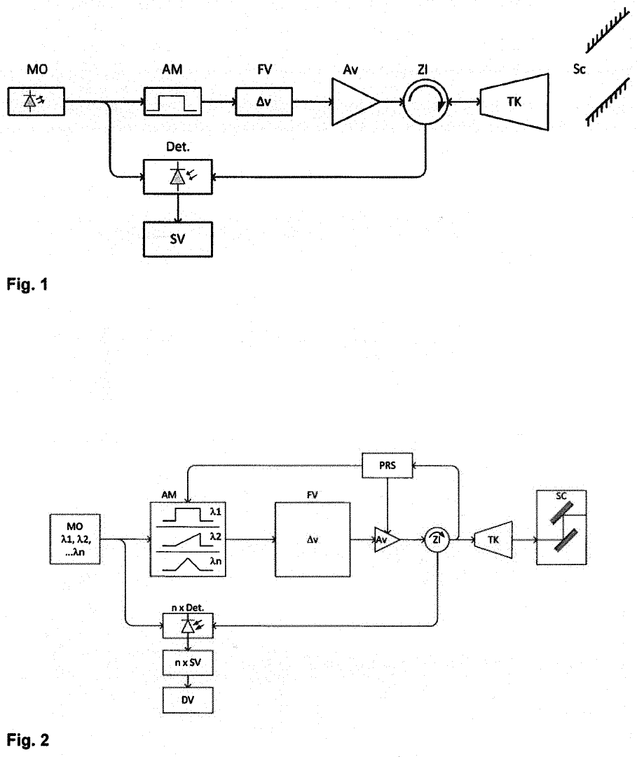

For measuring radial wind speed with a single-channel Doppler lidar known in the prior art, which comprises an optical transmitter, a transmit/receive switch (duplexer), a scanner, for example a two-axis scanner, a heterodyne receiver and a signal processor. A typical setup is described below with reference to FIG. 1.

FIG. 1 shows a configuration with a master oscillator (MO) generating a continuous laser light, which is used for pulse generation on the one hand and serves as a local oscillator on the other hand. An amplitude modulator (AM) generates the pulses of desired length and shape. A frequency shifter (FV) is also used to detect positive and negative directions of motion. These pulses are amplified (Av) and sent beam expanded into the atmosphere. A two-axis scanner (Sc) defines the measurement direction. The scattered light detected by a telescope (TK) and coupled into the optical system is guided to the balanced detector (Det.) by means of a transmit/receive splitter, here with the aid of a circulator (ZI). The backscattered signal can be mixed coherently (heterodyne) with the local oscillator, whereby only the low-frequency beat frequencies are measured by the detector and processed in the signal processing (SV). From this beat frequency the wind speed component can be calculated.

The purpose of a Doppler lidar is the spatially resolved measurement of the radial velocity of the wind velocity and preferably of the turbulence, e.g. at airports. The main problem is to achieve a high range while maintaining high spatial resolution, high measurement accuracy and high volume scanning speed.

The range is determined by the sensitivity of the system, which is given by the lidar equation:

$${P}_{R X} = {P}_{T X} \frac{c \cdot τ}{2} \frac{{K}_{SYS}}{{R}^{2}} {β}_{A} ( R , λ ) L [ α ( R , λ ) ] \qquad GI . 1$$

| | | | |
|---|---|---|---|
| P_{RX}: | Received Power | K_{SYS}: | System constant (aperture of |
| P_{TX}: | Transmitted | | the receiving optics, system |
| | pulse power | | efficiency, overlap of transmit- |
| c: | Speed of light | | ting and receiving beam) |
| τ: | Pulse duration | β_{A}(R, λ): | Backscatter coefficient of the |
| | | | atmosphere |
| n | Number of | L[α(R, λ)]: | Propagation damping function |
| | measurements | | |

GI. 1 describes the power received after emitting a single pulse.

For technical considerations, it is more common to use the signal-to-noise ratio (SNR):

$$\frac{{P}_{RX}}{N} = SNR = \frac{{P}_{TX}}{N} \frac{c \cdot τ}{2} \frac{{K}_{SYS}}{{R}^{2}} {β}_{A} ( R , λ ) L [ α ( R , λ ) ] \cdot \sqrt{n} \qquad GI . 2$$

To increase the sensitivity, the powers of several successively emitted pulses can be added and then the mean value calculated. Since this form of integration is incoherent, the signal-to-noise ratio of the measured value for PRX increases not with the number n of integrated measurements but with \sqrt{n}.

For a given SNR, the maximum range Rₘₐₓ can be calculated accordingly up to the distance, which the lidar can still detect targets:

$${R}_{max} = \sqrt{\frac{{P}_{TX}}{N} \frac{c \cdot τ}{2} \frac{{K}_{SYS}}{SNR} \cdot {β}_{A} \cdot L \cdot \sqrt{n}} \qquad GI . 3$$

The parameters that determine the influence of the lidar transmitter on the sensitivity or the measureable range of the lidar are summarized in the Figure of Merit (FOM) of the transmitter:

FOM=\sqrt{n}P_{TX}τ GI. 4

This Results in the Maximum Range:

$${R}_{max} = \sqrt{\frac{{P}_{TX}}{N} \frac{c \cdot τ}{2} \frac{{K}_{SYS}}{SNR} \cdot {β}_{A} \cdot L \cdot \sqrt{n}} = \sqrt{FOM \frac{1}{N} \frac{c}{2} \frac{{K}_{SYS}}{SNR} \cdot {β}_{A} \cdot L} \qquad GI . 5$$

The Spatial Resolution ΔR is:

ΔR=c·τ/2 GI. 6

The number of measurements n is an outcome of the pulse repetition frequency f_{P}, the effective beam θ with of the system, and the rotational speed of the scanner ω:

n=θ·f_{P}/ω GI. 7

The Range Rᵤₐ, Up to the Measurements are Still Unambiguous, is:

Rᵤₐ=c/(2·f_{P}) GI. 8

The maximum range Rₘₐₓ can be increased by increasing the transmitted pulse power P_{TX} and/or the pulse duration τ. However, both parameters are limited by the optical properties of the amplifier material. Increasing the pulse duration would also increase (degrade) the spatial resolution. As long as only one amplifier is used, only the number of measurements n can be increased.

The transmitted pulse power P_{TX} and the system constant K_{SYS} are specified by the state of the commercially available technology or, if necessary, can be optimized for the application (transmit/receive optics). The target parameters critical for the measurement quality are then still
the spatial resolution ΔR,
the maximum range Rₘₐₓ or the FOM,
the unambiguous range Rᵤₐ.

The available parameters to optimize are the pulse width, the pulse repetition frequency f_{P} (or the number of measurements n) and the pulse shape (rectangular, Gaussian or combination of both). The target parameters behave in contrary ways when the optimization parameters are varied, as shown in Table 1.

TABLE 1

| | τ increase | f_{P} Increase | Rect → Gauss |
|---|---|---|---|
| ΔR | Bad | Neutral | Bad |
| Rₘₐₓ, | Better | Better | Better |
| FOM | | | |
| Rᵤₐ | Neutral | Bad | Neutral |

The dilemma of a single-channel system can be significantly reduced, if instead of one channel, multiple channels are used, each having its master oscillator (MO) and receiver (Det.), with each channel operating with an optimized pulse shape. For stable and reliable operation of multiple wavelengths n simultaneously, an extension with a pulse control system (PRS) is necessary, as shown in FIG. 2.

In a system with multiple wavelengths n, each wavelength represents a separate measuring channel. Different channels can be optimized for different tasks. This optimization option already exists when only two channels are present.

The Master Oscillator (MO) generates and amplifies the continuous laser light on N channels. The wavelengths are chosen in such a way that the transmitted light is not absorbed by the constituents of the atmosphere. The minimum distance of the wavelengths between the channels corresponds to the still separable wavelengths with common optical methods. The maximum spacing of the wavelengths is determined by the gain bandwidth, or gain characteristics of the optical amplifier (Av). The number of wavelength channels is not limited.

The amplitude modulation (AM) can modulate the amplitude together for all channels or separately for each channel. The pulse length or shape can be freely selected. The generated pulses are frequency shifted (FV).

The generated and frequency-shifted pulses are amplified together in an optical amplifier (Av). A circulator (ZI) directs the pulses to the telescope (TK), which expands the laser beam of all wavelength and sends it into the atmosphere. The backscattered light from all wavelength-channels is re-collected by the telescope and passed through the circulator (ZI) to the detectors (n×Det.). Superposition with the local oscillator is performed separately for each channel on the respective detector (Det.), resulting in a separate heterodyne signal for each channel. Signal processing (SV) and digitization (DV) are initially performed separately for each of the n channels.

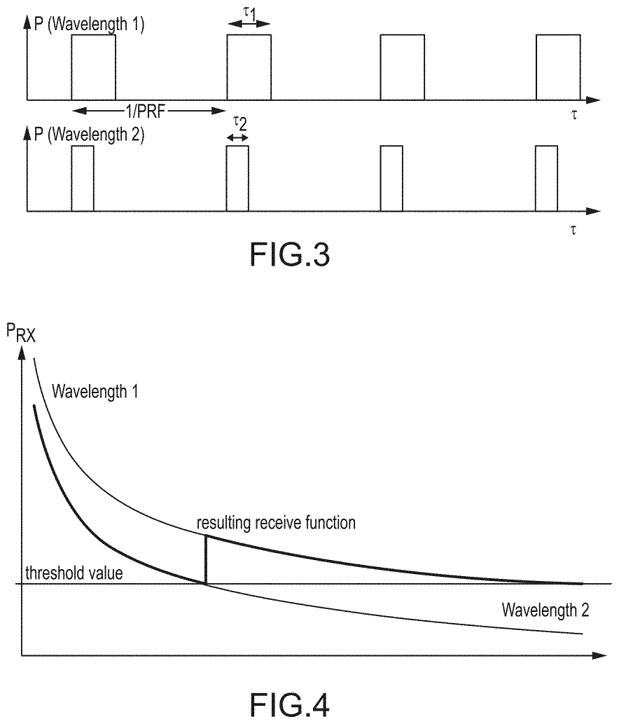

The combinations of pulse shape, pulse duration and pulse spacing of the different wavelengths or channels is called waveform in the following. The waveform shown in FIG. 3 makes it possible to optimize range and spatial resolution at the same time. Wavelength 1 emits long pulses that increase sensitivity and thus range. Wavelength 2 works with short pulses that provide high spatial resolution, but their range is shorter. As long as a predefined SNR threshold is not undershot, the data channel of wavelength 2 is used, then it is switched to wavelength 1. In this way, measurements are made in the near range with high spatial resolution and in the far range with coarser resolution but higher range. FIG. 3 shows the waveform with two wavelengths of different pulse widths, and FIG. 4 shows the associated receive function.

It is also possible to add the signal powers of both channels to get a better SNR. The resulting spatial resolution is at least as good as that of the channel with the longer pulse width. With the accumulation of both channels it can be achieved that the sensitivity and thus the range is once again increased somewhat.

The choice of pulse shape has an additional influence to an increased range or spatial resolution. A rectangular pulse has an increased spatial resolution, while a Gaussian pulse has an increased range due to the lower system bandwidth. These characteristics are additionally used to extend the possible measurement range. This is realized by setting one channel for the far range to a Gaussian shaped pulse and for the near range the other channel to a square shaped pulse with edges as steep as possible.

A possible pulse shape and pulse length combination is the convolution between Gaussian and square pulses of different pulse lengths. In the following formula this is expressed with the coefficient D, which can take a value from 0 to 1.

P_{W}(t)=P_{G}(D·τ_{FWHM})*P_{R}((1−D)·τ_{FWHM})

In general, any pulse shape or combination of different pulse shapes can be used to match the native pulse bandwidth and spatial resolution.

The channels with shorter pulses have a shorter range, which means that the pulse repetition frequency can be set higher for the channel. A higher pulse repetition frequency has a positive effect on the SNR of the respective channel.

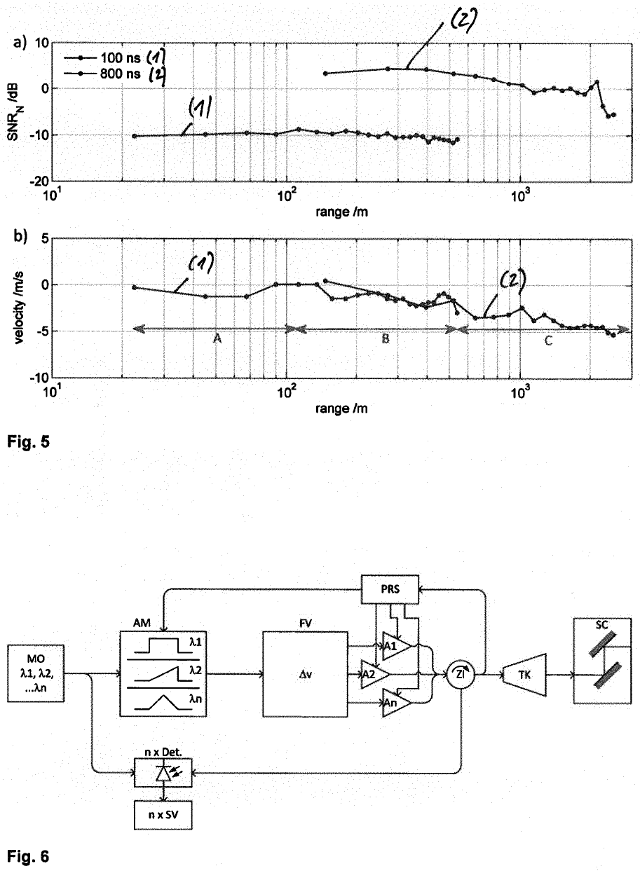

The result of an example measurement is shown in FIG. 5. Two wavelength channels were used for this purpose. One channel (1) was parameterized with a pulse length of 100 ns, the other channel (2) with 800 ns pulse length. Both pulse shapes of the wavelengths were rectangular and were used with the same pulse repetition rate.

The SNR of channel (1) with the short pulse provides a low SNR due to the lower energy and higher bandwidth, which leads to a low range. This channel covers the close range (range A+B: here up to 500 m) with high spatial resolution (the full spatial resolution is given here by the distance of the points in the figure). Channel (2) provides usable data only after 150 m with considerably worse spatial resolution, but with an increased range (range B+C: here up to 2.5 km). Both channels cover the intersection area (area B). Here, measurement data with increased spatial resolution and velocity resolution are available.

Single-channel systems would only provide one of the two measurement series. Thus, the user of conventional methods always makes a compromise between minimum range, spatial resolution and maximum range.

A higher average power and thus a higher sensitivity allow individual amplifiers (A1), (A2) to (An) for each channel. The system is shown in FIG. 6.

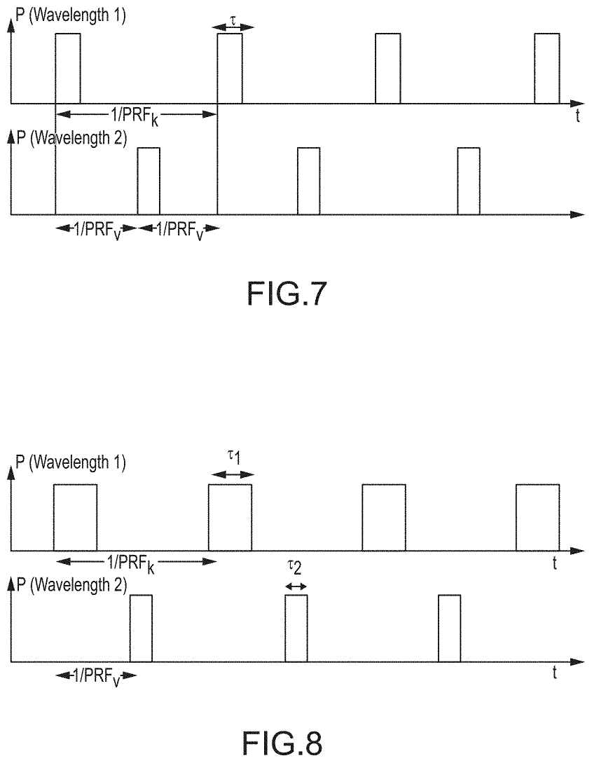

By shifting the transmit pulses of wavelength 1 and 2 in time, shown in FIG. 7, the transmit amplifier can be used more efficiently and the PRF can be doubled, effectively giving PRFᵥ. However, the unambiguous range results from the PRF_{K} of the individual channels.

By increasing the number of received signals, the sensitivity of the lidar and thus its range was increased.

Pulses can also be shifted in time when operating with different pulse widths, as shown in FIG. 8. Here, the effectiveness of the transmit amplifier can also be improved.

Although the sensitivity of a lidar can be increased via the PRF, as GI. 2 shows, a higher PRF reduces the unambiguous range, even when using multiple channels with pulses shifted in time from each other, being disadvantageous.

In addition, the waveform of the lidar, which results from the superposition of the individual channels i.e. the PRF, the pulse duration and the pulse shape of each individual channel, must be manually adjusted to each weather situation, which makes automatic operation difficult.

An object of the invention is therefore to create a Doppler lidar that makes atmospheric effects visible in clear weather, while at the same time enabling optimization of range, spatial resolution and velocity resolution. The Doppler lidar should have a compact design. Furthermore, the transmission pulse power should be selectable to optimize for different application areas.

This task is solved by the features of claim 1.

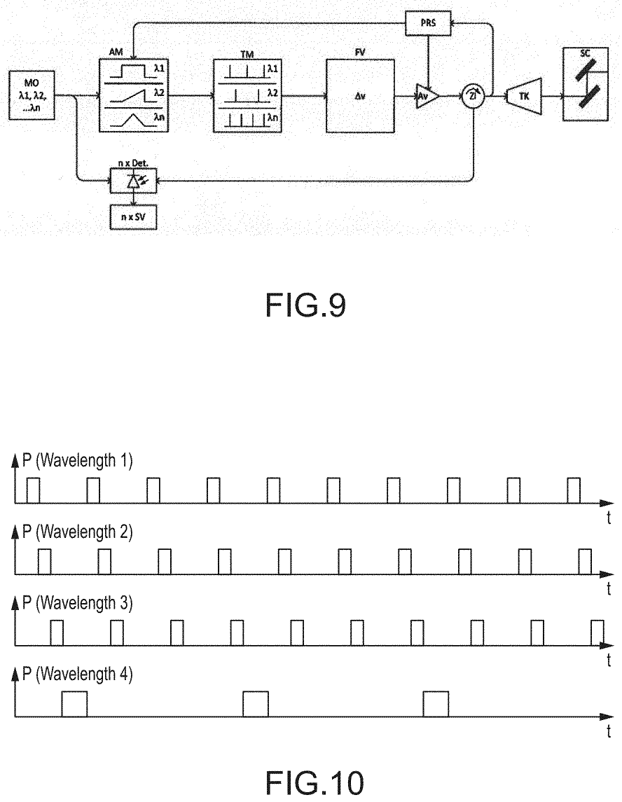

Hereby a Doppler lidar is created that is based on the use of a multi-wavelength Doppler lidar system. FIG. 9 shows the block diagram of such a system. This system can be realized as free-beam optics or as fiber technology.

The Doppler lidar, which is the subject of the invention, uses multiple channels N, where each channel can operate with its own pulse repetition frequency PRF (Pulse Repetition Frequency) or pulse repetition period PRT (Pulse Repetition Time) in addition to its individual pulse shape. The state of the art only describes operation with the same but offset PRT for each channel. The individual control of the PRF/PRT is controlled by the Timing Modulator (TM). The sampling is optimized because each channel has its own unique range of distances. For example, it is possible to run multiple channels at a very high PRF to achieve high sensitivity, with one channel running in parallel at a low PRF to check if the channels running at high PRF are detecting targets outside the unambiguous range (2nd trip echoes).

Thus, essential to the invention is the use of different pulse repetition frequencies and pulse spacing for each channel.

Preferably, each of the multiple channels is equipped with its own frequency modulator in addition to the individual pulse shape. The frequency modulator can switch off each channel individually. The use of individual frequency modulators for each channel allows an extension of the measurable ranges of wind speeds.

Further preferably, adaptive/cognitive waveform optimization is used. The lidar can use its own measurement data to optimize its waveform itself. The optimization can also be done with the help of external sensors.

Further embodiments of the invention can be learnt gran the following description and the dependent claims.

Below, the invention is explained in more detail with reference to the embodiments shown in the accompanying figures.

FIG. 1 shows a block diagram of a prior art single channel Doppler lidar,

FIG. 2 shows a block diagram of a prior art multi-channel Doppler lidar with individual pulse shape,

FIG. 3 shows waveforms with two wavelengths of different pulse widths according to the state of the art,

FIG. 4 shows a receiving function according to FIG. 3,

FIG. 5 shows an example measurement with two wavelength channels,

FIG. 6 shows a block diagram of a prior art multi-channel Doppler lidar with individual pulse shape and individual amplifiers,

FIG. 7 shows the time offset of the transmitted pulses of wavelengths 1 and 2 according the state of the art,

FIG. 8 shows the time offset of the transmission pulses of wavelengths 1 and 2 with different pulse widths according to the prior art,

FIG. 9 shows a block diagram of a multi-channel Doppler lidar with individual pulse shape and their own pulse repetition frequency (PRF)/pulse intervals (PRT) according to a first embodiment of the invention,

FIG. 10 shows an example according to FIG. 9 for individual timing with four channels,

FIG. 11 shows a block diagram of a multi-channel Doppler lidar with individual pulse shape, preferably individual pulse repetition frequency (PRF)/pulse spacing (PRT) (not shown) and individual frequency modulation according to a second embodiment of the invention,

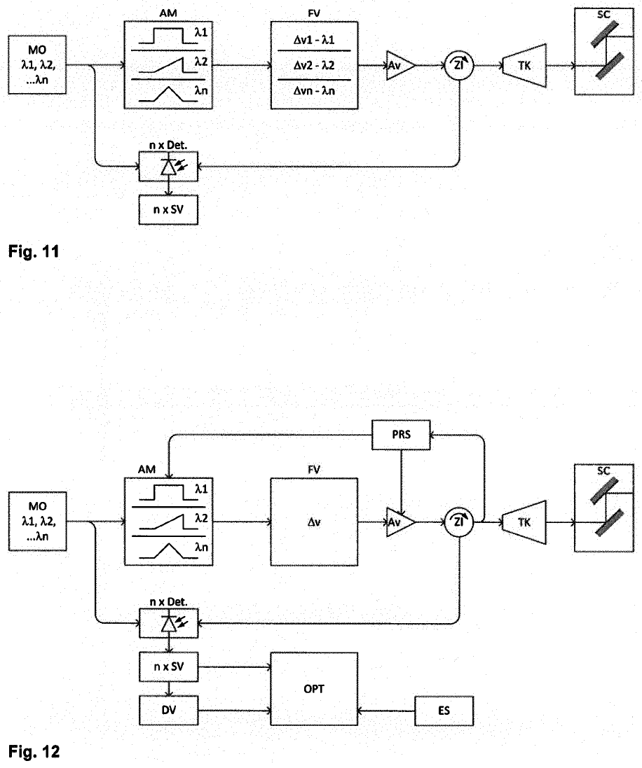

FIG. 12 shows a block diagram according to FIG. 11 with optimized waveform according to a third embodiment of the invention,

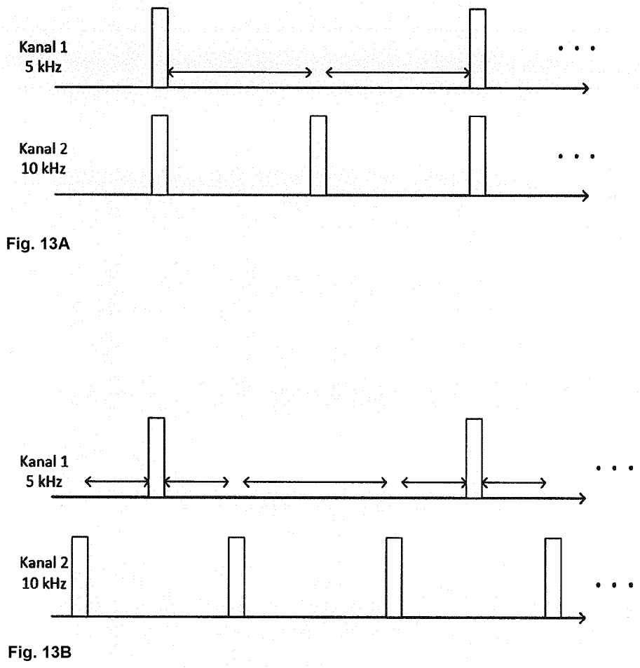

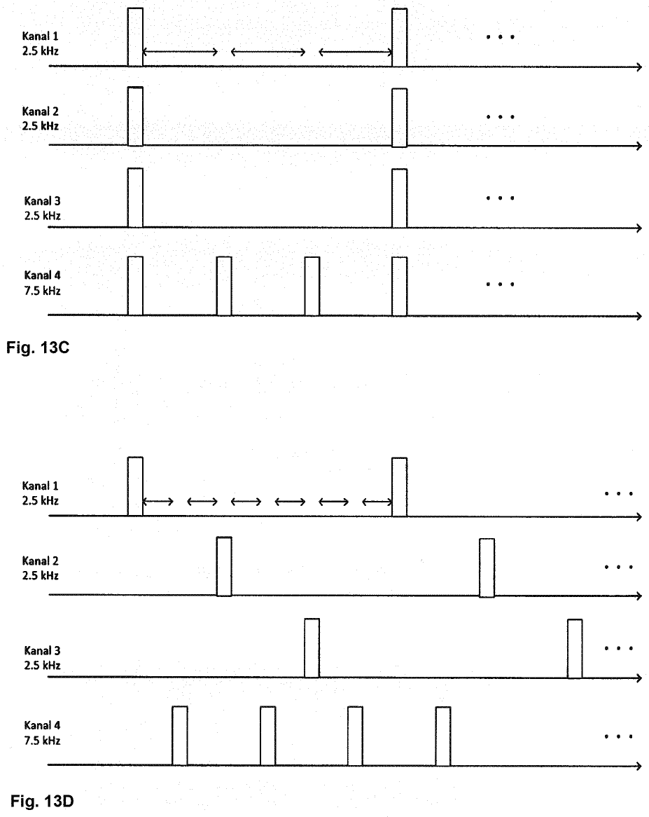

FIG. 13A to 13D show non-optimized and optimized pulse sequences for two/four channels respectively according to the invention,

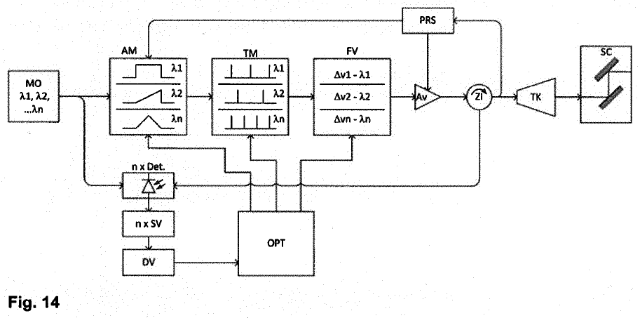

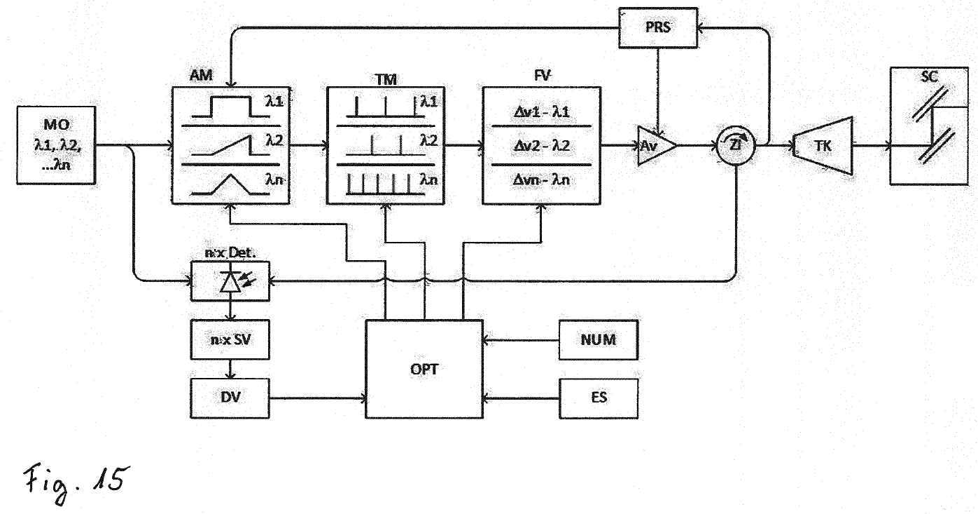

FIG. 14 shows a block diagram of a multi-channel Doppler lidar with individual pulse shape, individual pulse repetition frequency (PRF)/pulse spacing (PRT), individual frequency modulation, and optimization of the waveform by self-optimization according to a fourth embodiment of the invention,

FIG. 15 shows a block diagram of a multi-channel Doppler lidar with individual pulse shape, individual pulse repetition frequency (PRF)/pulse spacing (PRT), individual frequency modulation, and optimization of the waveform by self-tuning and/or optimization using external sensors or numerical models according to a fifth embodiment of the invention,

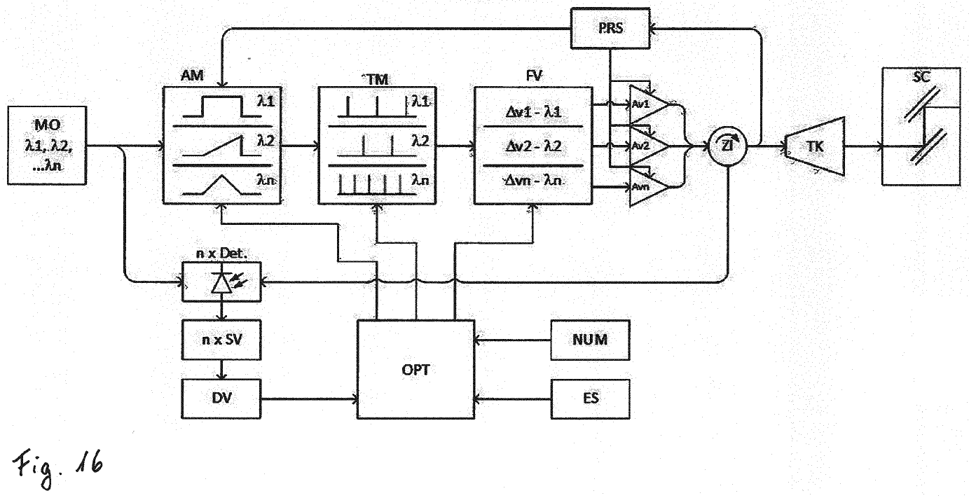

FIG. 16 shows a block diagram corresponding to FIG. 15 and individual amplifiers according to a sixth embodiment.

The invention relates to a multi-wavelength Doppler lidar as shown in FIG. 9 according to a first embodiment.

In the system with multiple wavelengths n, each wavelength represents a separate measuring channel. Different channels can be optimized for different tasks.

The master oscillator (MO) generates and amplifies the coherent laser light on N channels. Preferably, coherent light pulses are generated, which are ultra-short light pulses in particular. The wavelengths are chosen in such a way that they are not absorbed by the constituents of the atmosphere. The minimum distance of the wavelengths between the channels corresponds to the still separable wavelengths using common optical methods. The maximum spacing of the wavelengths is determined by the gain bandwidth or gain characteristics of the optical amplifier (Av). The number of wavelength channels is not limited.

Preferably, the wavelengths are in the near-infrared spectrum (1.55 μm). Due to this characteristic wavelength, the signal is scattered by aerosol particles and cloud droplets as it passes through the atmosphere. A portion of the backscattered infrared signal is received by the Doppler lidar detector. The cause of detected frequency shifts is the natural motion of the backscattering aerosol and cloud particles (Doppler effect), from which the radial wind is derived.

The amplitude modulation (AM) can be done together for all channels or separately for each channel. The pulse length or shape can be freely selected. The generated pulses are frequency shifted (FV).

The generated and frequency-shifted pulses are amplified together in an optical amplifier (Av). A circulator (ZI) directs the pulses to the telescope (TK), which expands the laser beam of all wavelengths and sends it into the atmosphere. The backscattered light from all wavelength channels is re-collected by the telescope and passed through the circulator (ZI) to the detectors (n×Det.). Superposition with the local oscillator is performed separately for each channel on the respective detector (Det.), resulting in a separate heterodyne signal for each channel. Signal processing (SV) and any digitization (DV) is initially performed separately for each of the n channels.

The combinations of pulse shape, pulse duration and pulse spacing of the different wavelengths or channels is called waveform in the following.

The Doppler lidar, which is the subject of the invention, uses multiple channels N, where each channel can operate with its own pulse repetition frequency (PRF) or pulse repetition time (PRT) in addition to its individual pulse shape. The individual control of the PRF/PRT is controlled by the Timing Modulator (TM). Sampling is optimized because each channel has its own unique range. For example, it is possible to run multiple channels at a very high PRF to achieve high sensitivity, with one channel running in parallel at a low PRF to check if the channels running at high PRF are detecting targets at overreach (2nd trip echoes). An example of individual timing is shown in FIG. 10.

The Doppler lidar according to the invention can consequently generate and evaluate different repetition frequencies, pulse shapes and durations simultaneously. In doing so, all N channels can be combined or compared with each other using different algorithms. An increase in spatial resolution with a simultaneous increase in range by means of different pulse repetition rates, pulse shapes and pulse spacing is the result.

FIG. 11 shows a second embodiment of the invention with individual frequency modulators. The Doppler lidar, which is the subject of the invention, uses multiple channels N, with each channel having its own frequency modulator in addition to the individual pulse shape. This is controlled by the frequency modulator FV. The frequency modulator can turn off each channel individually, which prevents interfering light from entering the system during the channel's pause periods between pulses. Also, a different frequency offset (Δv1, Δv2, . . . ) can be selected for each channel, expanding the unique range of wind speeds that the lidar can measure. Preferably, this Doppler lidar system also uses the timing modulator (not shown) as described to FIG. 9.

FIG. 12 shows a third embodiment of the invention with automatic optimization of the waveform. The Doppler lidar, which is the object of the invention, uses multiple channels N, where the individual pulse shape of the channels or the waveform is automatically adapted to the particular measurement situation and task. The situation is determined by the current state of the environment (e.g. aerosol density, weather conditions, temperature, air pressure, humidity). The state can be detected by external sensors ES or derived from the signal or data processing SV, DV of the lidar. The sensor data are recorded by an optimizer OPT. The optimizer can determine the optimum waveform based on historical data and known physical relationships. It is also able to optimize the waveform independently by varying it. Known artificial intelligence (AI) or machine learning techniques can be used for this purpose, for example.

For example, shorter pulses measure more effectively with increased turbulence. Thus, with increased turbulence in the atmosphere, shorter pulses with higher PRFs would be expected to provide a longer range. Different PRFs could then also be used to increase the unique range through second trip recovery.

The technical effect of the features described above, and preferably according to the invention provided, are summarized in Table 2 in terms of the advantages/effects. The features according to the invention can be combined independently of each other. Preferably, they are realized together.

TABLE 2

| Features according | Effects of the features according to the |
|---|---|
| to the invention | invention |
| Individual PRF/PRT | Higher unambiguous range due to different |
| | PRFs (second trip detection) |
| Individual frequency | Increase the sensitivity by switching off the |
| modulators | channels in your pause times |
| | Increase of the unique speed range through |
| | different frequency offsets |
| Automatic optimization | Interventions of the user and the operational |
| of the waveform | support effort are reduced drastically. |

FIG. 13A and FIG. 13B show an example of an optimized pulse sequence for second trip correction with different PRFs.

FIG. 13A shows a non-optimized pulse sequence for channel 1 and channel 2. The average pulse spacing is approx. (100 μs+100 μs)/2=100 μs. FIG. 13.2 shows optimized pulse spacing of the minimum mean time of approx. (50 μs+100 μs+50 μs)/3=66 μs. This reduces the spontaneous emission ASE (Amplified spontaneous emission) in the fiber amplifier and increases the pulse energy and thus the performance of the overall system. In this example, the amplifier operates optimally at approx. 15 kHz.

FIG. 13C and FIG. 13D show an example of an optimized pulse sequence for reducing the blind range with different PRFs and pulse lengths for 4 channels, for example.

As FIG. 13B shows, there is an unambiguous range of 60 km, but the optical amplifier is poorly seeded (7.5 kHz). FIG. 13.2 shows an unambiguous range of 60 km, but the optical amplifier is now optimized (15 kHz).

FIG. 14 shows a fourth embodiment of the invention with an automatic (self-)optimization of the waveform. The Doppler lidar, which is the object of the invention, uses multiple channels N, where the individual pulse shape of the channels or the waveform can be automatically adapted to the particular measurement situation and measurement task. The situation can be determined by the current state of the environment (e.g., aerosol density, weather conditions, temperature, air pressure, humidity). The lidar uses its own measurement data to optimize its waveform itself. This is done by an optimizer (OPT). The optimizer (OPT) is preferably a computer with suitable software that can control the amplitude modulation (AM), timing modulator (TM), and frequency modulator (FV) function blocks. The software can implement execution from programmed algorithms that calculate the optimal waveform based on historical data and known physical relationships. Furthermore, artificial intelligence can be used that trains itself or that is trained.

For example, shorter pulses measure more effectively in the presence of increased turbulence; thus, in the presence of increased turbulence in the atmosphere, shorter pulses with higher PRF are associated with a higher range can be expected. Different PRFs can then also be used to increase the unique range through second trip recovery.

An example of self-optimization is shown in Table 3. In this case, the lidar optimizes itself so that the energy dissipation rate is optimally measured.

TABLE 3
Case differentiation according to Energy Dissipation
Rate or refractive turbulence.

| | Pulse length | | |
|---|---|---|---|
| EDR o. Cn² | (FWHM) | Pulse shape | eff. PRF |
| Calm | 1000 ns | Gauss | 15 kHz |
| Weak | 800 ns | 0.75 Gauss*0.25 | 16 kHz |
| | | Rect | |
| Middle | 500 ns | 0.25 Gauss*0.75 | 18 kHz |
| | | Rect | |
| Strong | 300 ns | Rect | 20 kHz |

FIG. 15 shows a fifth embodiment of the invention, in which, in addition to the previously described self-optimization according to the fourth embodiment, optimization can also be performed with the aid of external sensors (ES). In addition to external sensors (ES), data can also be supplied to the optimizer (OPT) from numerical models (NUM).

FIG. 16 shows a sixth embodiment of the invention, in which, in addition to the formation of the Doppler lidar according to the fifth embodiment, individual amplifiers (A1), (A2) to (An) are provided for each channel. A higher average power and thus a higher sensitivity is thus made possible.

The invention enables accurate measurement of the wind velocity vector in real time using pulsed laser beams which are backscattered by air molecules and aerosols. Due to the structure of the lidar according to the invention and the evaluation method according to the invention, a large range can be achieved, and only at low backscatter intensities. In particular, the use of different pulse repetition frequencies/pulse spacing for each channel enables advantageous measurement systems. For example, 2nd trip recovery means that one is able to reverse or prevent interference. If one runs a lidar channel with low PRF and correspondingly high unambiguous range, then it can detect targets at long range, but one can at best undo the interference on the lidar channels with high PRF where no 1st trip echoes were measured.

In addition to applications on the ground, for example for the detection of wind speeds, wind shear, turbulence and other wind and weather situations, especially at airports, the Doppler lidar according to the invention can be used with possibly adapted transmission pulse power, for example on wind turbines and/or on board land, air and/or water vehicles.

To Summarize:

The invention relates to a Doppler lidar for detecting wind speeds, comprising a device (MO) for generating pulsed coherent laser light on N wavelength channels, amplitude modulation (AM) being performed separately for each individual wavelength channel to shape the pulse individually for each channel, a device (TK, SC) for transmitting generated, frequency-shifted and amplified pulses of the laser light in predetermined spatial directions, a detector (n×Det.) for receiving the generated and the backscattered laser light on N wavelength channels, and an electronic evaluation device (n×SV) for determining a Doppler shift amount between the transmitted light and the received light on N wavelength channels, wherein a timing modulator (TM) is assigned to the N wavelength channels for individual control of a pulse repetition frequency (PRF) and/or pulse repetition period (PRT) in addition to the pulse shape for wavelength channels.

The Timing Modulator (TM) controls different pulse repetition frequencies (PRF) and/or pulse repetition periods (PRT) for each of the N wavelength channels.

Individual frequency modulators for frequency shifting (FV) are provided, so that the generated pulses or pulse sequences can be frequency-shifted separately for each of the N wavelength channels.

The laser light is emitted into the atmosphere at a frequency f (T) as transmitting light and at a frequency f(R) as receiving light, which is received by scattering the laser light due to aerosol present in the atmosphere, thereby detecting a wind speed of the airflow in a remote area.

For an automatic optimization of the individual pulse shape of the N-wavelength channels, an optimizer (OPT) is provided, which detects meteorological phenomena such as winds, wind shear and turbulence by at least one external sensor (SE) and adapts the waveform to the respective measurement situation.

The optimizer (OPT) is designed for self-tuning of the waveform, for which its own measurement data is fed to the optimizer (OPT) and it has control access to the amplitude modulation (AM), the timing modulator (TM) and/or the individual frequency modulators (FV).

The optimizer (OPT) is designed as a computer with its own software, where the software implements an optimal waveform for the wavelength channels based on historical data and physical relationships.

An artificial intelligence for teaching the optimizer (OPT) is provided.

The invention now being fully described, it will be apparent to one of ordinary skill in the art that many changes and modifications can be made thereto without departing from the spirit or scope of the appended claims.

1. Doppler lidar for detecting wind speeds, comprising a device (MO) for generating pulsed coherent laser light on N wavelength channels, amplitude modulation (AM) being performed separately for each individual wavelength channel for shaping the pulse individually for each channel, a device (TK, SC) for transmitting generated, frequency-shifted and amplified pulses of the laser light in predetermined spatial directions, a detector (n×Det.) for receiving the generated and the backscattered laser light on N wavelength channels, and an electronic evaluation device (n×SV) for determining a Doppler shift amount between the transmitted light and the received light on N wavelength channels, and a timing modulator (TM) is assigned to the N wavelength channels for individual control of a pulse repetition frequency (PRF) and/or pulse repetition period (PRT) in addition to the pulse shape for wavelength channels.

2. Doppler lidar according to claim 1, wherein the timing modulator (TM) controls different pulse repetition frequencies (PRF) and/or pulse repetition periods (PRT) for each of the N wavelength channels.

3. Doppler lidar according to claim 1, wherein individual frequency modulators are provided for frequency shifting (FV), so that the generated pulses or pulse sequences are able to be separately frequency shifted for each of the N wavelength channels.

4. A Doppler lidar according to claim 1, wherein the laser light is emitted into the atmosphere at a frequency f (T) as transmitting light and received at a frequency f(R) as receiving light, which is received by scattering the laser light due to aerosol present in the atmosphere, to thereby detect a wind speed of the airflow in a remote area.

5. Doppler lidar according to claim 1, wherein for an automatic optimization of the individual pulse shape of the N-wavelength channels an optimizer (OPT) is provided which detects metrological phenomena such as winds, wind shear and turbulence by at least one external sensor (SE) and adapts the waveform to the respective measurement situation.

6. Doppler lidar according to claim 1, wherein the optimizer (OPT) is designed for self-optimization of the waveform, for which purpose the own measurement data are fed to the optimizer (OPT) and the latter has control access to the amplitude modulation (AM), the timing modulator (TM) and/or the individual frequency modulators (FV).

7. Doppler lidar according to claim 5, wherein the optimizer (OPT) is designed as a computer with its own software, the software implementing an optimal waveform for the wavelength channels based on historical data and physical relationships.

8. Doppler lidar according to claim 5, wherein an artificial intelligence is provided for teaching the optimizer (OPT).
